(19) United States
(12) Patent Application Publication
(10) Pub. No.: US 2006/0033471 A1
(43) Pub. Date: Feb. 16, 2006

(54) Charger for battery with charging cable

(76) Inventors: Hans-Hermann Maasland, Quickborn (DE); Michael Opitz, Nahe (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/194,836

(22) Filed: Aug. 1, 2005

(30) Foreign Application Priority Data
Aug. 10, 2004 (DE) 10 2004 038 680.3

(51) Int. Cl. H02J 7/02

(52) U.S. Cl. 320/111

(57) ABSTRACT

Charger for a battery which is connected to a plug via a charging cable and which cooperates with a socket connected to the battery, the plug comprising a plug housing in which plug pins connected to the charging cable are arranged and means being associated with the plug which react when the plug and socket are mechanically disconnected and the means generate a signal which causes the charger to switch off, characterised in that the plug comprises a handle which may be manually grasped and with which the plug is pulled out of the socket and a switching element is associated with the handle which is actuated upon disconnection and is connected to the charger via a signal path.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

A large proportion of industrial trucks are battery-driven. Naturally, it is necessary to charge the batteries periodically. This takes place either by removing the battery and transporting it to a charging station or by charging in the industrial truck, the charger required therefor being arranged either outside the industrial truck or carried with the industrial truck.

A typical charger uses a power pack which may be connected to the standard three phase network or single phase network. It further comprises a converter to generate a desired direct current of a predetermined voltage. It is usual that the charger is coupled to the battery via a charging cable. It is furthermore usual to associate a female plug part (socket) to the battery and a male plug part (plug) to the charger. For charging purposes the plug parts are connected to one another and it is usual with current chargers that the charging of the battery is automatically initialised. In this connection, the charger uses means which determine when a connection has been made to the battery. Moreover, the charger also uses a manually actuatable switch for starting and finishing the charging.

If the charging plug of the charger is pulled out of the socket of the battery, it has to be ensured that at the time of disconnection no current flows from the charger to the battery, as sparks are otherwise generated. Furthermore, there is the risk that the operator puts a hand into the plug and touches the plug pins. The operator would be subjected to a voltage if the plug pins were not switched off.

It has become known from DE 101 51 163 A1 to provide pilot- or auxiliary contacts in addition to the conventional plug connector and which are connected on the plug side to a control part of the charger. If the plug is pulled out of the socket, firstly the auxiliary contacts react and cause the charger to switch off. It has been proved, however, that by pulling out the plug, a time gain is only achieved in the millisecond range. If the detection is carried out via a computer which additionally operates relays or contactors as time-delaying components, a further extended delay is produced until the charger is switched off.

The object of the invention is to design a plug for the charging cable of a charger such that the charger is switched off in time before the socket and the plug are disconnected.

### BRIEF SUMMARY OF THE INVENTION

According to the invention, the plug comprises a handle which may be grasped manually and with which the plug is pulled out of the socket. A switching element is associated with the handle which is manually actuated when the plug is disconnected. The switching element is connected to the charger via a signal path. Said connection may be made via an additional line in the charging cable. Alternatively, the signal path may itself be formed by a conductor of the charging cable, transmission from the switching element to the charger being carried out via a high frequency (HF) signal. It is understood that the switching element is coupled to a corresponding transmission element and the charger comprises a corresponding receiver element in order to transmit corresponding pulses to the charger via the conductor of the charging cable.

Finally, a wireless transmission link may also be provided to transmit signals from the switching element to the charger, for example via radio or an infrared link. In this case, a transmitter is also required in the plug and a receiver in the charger for the transmission of the signal that the socket and plug have been disconnected. It is naturally also conceivable to arrange a transmitter and a receiver both in the plug and in the charger in order to allow communication also in the opposing direction.

The invention is based on the recognition that to disconnect the plug from the socket a certain pulling force is required which is exerted via the handle on the housing of the plug. Said pulling force may additionally be used to actuate the switching element. As the pulling force is applied at a time when the contacts of the plug and socket are not disconnected in any way, the charger may inevitably be switched off in time.

Different solutions are possible in order to implement the disclosed ideas constructively. One solution according to an embodiment of the invention is that the handle comprises a grip portion extending transversely to the axis of the plug, a switching element being arranged on the pulling side of the grip portion which is manually actuated when a pulling force is applied to the grip portion. The switch used therefor is, according to a further embodiment of the invention, a so-called wave switch. It is adapted to the inner face of the grip portion and the corresponding actuation portion may be grasped by the entire hand as the pulling force to be applied to the housing also has to be applied thereby.

It is thus conceivable to provide a direct connection between the switch on the grip portion or on the handle to the charger. It is however to be preferred if the signal path is formed between the plug housing and the charger as has already been disclosed above. In this case an auxiliary cable is provided between the switch and the plug housing in order to transmit the signal generated by the switch, firstly into the plug housing and from there subsequently to the charger.

A further embodiment of the invention provides that the handle is mounted with restricted movement on the housing and the switching element is arranged in the housing and reacts to the relative movement of the handle and the housing. The handle may, for example, be formed by a U-shaped grip, the branch ends of which being connected to the housing. To this end, a support with restricted movement may be provided on the housing so that pulling the handle leads to a displacement of the branch relative to the housing which may be recorded by means of a suitable sensor or the like. To this end, it is expedient if the handle is tensioned by a spring against the pulling direction. The recording of the relative movement may, for example, be carried out via a reed contact, via a magnetic sensor or in another manner.

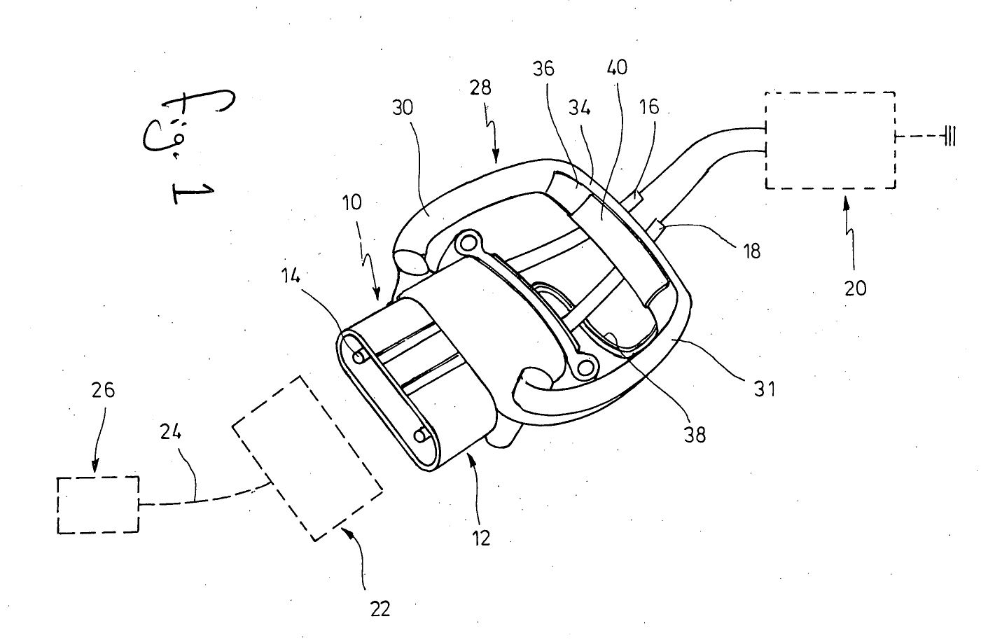

FIG. 1 shows a perspective view of a plug of a charging cable for a charger according to the invention.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

In FIG. 1 a plug is generally referred to by 10. It comprises a plug housing 12 which, at the left end in the Figure, receives three plug pins 14. The outer plug pins 14 are used for power transmission. The plug pins 14 are connected to power cables 16, 18, which are fed out at the right end of the housing 12 in the Figure. They are connected to a charger 20 shown in dotted lines. The charger is on mains voltage.

The plug 10 cooperates with a socket 22 shown diagrammatically which is connected to a battery 26 shown in dotted lines via a cable 24. On the whole, the disclosed parts resemble conventional systems.

It can be seen in the Figure that a U-shaped grip 28 is connected to the housing 12 which is of generally oval cross-sectional shape. The branches 30, 31 are attached at the sides to the housing 12. They may be screwed to the housing in an appropriate manner. It is also conceivable that the grip 28 is integrally constructed with the housing 12 and made from plastics material. The web 34 of the grip 28 extends approximately transversely to the longitudinal axis of the housing 12 and is bent slightly outwards. On the inner face a strip 36 is attached which is adapted to the contour of the grip portion 34 and which carries a switch contact in the centre region which is connected to an auxiliary cable 38. A second switch contact is formed by an elongate part 40 which extends over its greatest length approximately in the centre of the grip portion 34 and in turn is adapted to its contour. It is mounted in an appropriate manner (not shown) and tensioned, so that the switch formed is usually in the open position. If a force is exerted on the strip 40, by an operator grasping the,grip portion 34 and pulling to the right in the Figure, the switch is closed. Said switch is a wave switch as is usual in safety engineering, in motor vehicle construction, etc.

The switch is connected to the interior of the housing 12 via the auxiliary cable 38. From there the status of the switch is transmitted to the charger via a signal path, not shown in more detail. The signal path may, for example, be formed by an additional cable or an additional conductor in one of the cables 16, 18. In this case, a corresponding circuit in the charger 20 is optionally short-circuited or broken via the switch. Alternatively it is possible to set up a wireless signal path between the housing 12 and the charger 20 or to carry out a transmission via HF via one of the conductors of the cables 16, 18.

In place of a switch, as is shown in the Figure, it is also possible to mount the branches 30, 31 with restricted movement on the housing 12 and when grasping the grip 28 and pulling hard away from the housing 12 to actuate a switching element, the signal of which being transmitted in turn to the charger 20 in the manner already disclosed.

By means of the disclosed, shown and alternative solution it is possible to switch off the charger 20 before the socket 22 and the plug 10 are finally disconnected.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. Charger for a battery which is connected to a plug via a charging cable and which cooperates with a socket connected to the battery, the plug comprising a plug housing in which plug pins connected to the charging cable are arranged and means being associated with the plug which react when the plug and socket are mechanically disconnected and the means generate a signal which causes the charger to switch off, characterised in that the plug (10) comprises a handle which may be manually grasped and with which the plug (10) is pulled out of the socket (22) and a switching element is associated with the handle which is actuated upon disconnection and is connected to the charger (20) via a signal path.

2. Charger according to claim 1, characterised in that the signal path is formed by an additional line in the charging cable.

3. Charger according to claim 1, characterised in that the signal path is formed by a conductor of the charging cable and the signal is transmitted via HF from the switching element to the charger (20).

4. Charger according to claim 1, characterised in that a wireless transmission link is provided between the plug (10) and the charger (20) and one respective transmitter/receiver is associated with the plug (10) and the charger (20).

5. Charger according to claim 1, characterised in that the handle comprises a grip portion extending transversely to the axis of the plug with a pulling side on which a pulling force for disconnecting the plug (10) is applied manually and the switching element is arranged on the pulling side.

6. Charger according to claim 5, characterised in that the switch is a wave switch (36, 40).

7. Charger according to claim 1, characterised in that the signal path is formed between the plug housing and the charger and the switching element is connected to the housing (12) via an auxiliary cable (38).

8. Charger according to claim 1, characterised in that the handle is mounted with restricted movement on the housing and the switching element is arranged in the housing and reacts to the relative movement of the handle and the housing.

9. Charger according to claim 1, characterised in that the handle is formed by a U-shaped stirrup-like grip (28), the branches (30, 31) of which being connected to the plug housing (12).

10. Charger according to claim 5, characterised in that the web (34) of the U-shaped grip (28) forms the grip portion.
